(19) United States
(12) Patent Application Publication
(10) Pub. No.: US 2006/0224855 A1
(43) Pub. Date: Oct. 5, 2006

(54) Device and method for accessing memory

(75) Inventors: Kuan-Jui Ho, Shindian City (TW); Hsiu Ming Chu, Shindian City (TW)

Correspondence Address: BIRCH STEWART KOLASCH & BIRCH, PO BOX 747, FALLS CHURCH, VA, 22040-0747, US

(73) Assignee: VIA Technologies, Inc.

(21) Appl. No.: 11/174,462

(22) Filed: Jul. 6, 2005

(30) Foreign Application Priority Data
Apr. 1, 2005 (TW) 094110641

(51) Int. Cl. G06F 12/00

(52) U.S. Cl. 711/173

(57) ABSTRACT

A device for accessing a memory includes a memory module, a CPU and a north bridge chipset. The memory module has an ordinary area and a redundant area. The CPU outputs redundant address data. The north bridge chipset includes a memory module controller, a data register and a pointer. The pointer records the redundant address data. When a writing procedure is performed, the data register records to-be-stored data, and the memory module controller stores the to-be-stored data to a first physical address of the redundant area according to the pointer and the data register. In addition, when a reading procedure is performed, the data register records a to-be-read amount, and the memory module controller reads to-be-read data from a second physical address of the redundant area according to the pointer and the data register.

### BACKGROUND OF THE INVENTION

1. Field of Invention

The invention relates to a device and a method for accessing a memory, and more particularly to a device and a method applied to a situation when the memory capacity exceeds the memory space supported by the operation system.

2. Related Art

The memory used in typical computers is the DRAM (Dynamic Random Access Memory), which has the capacity that is getting larger and larger with the advance of the technology. The increasing capacity of the DRAM is an inevitable trend and the price of the DRAM is also accepted by the ordinary consumers. Thus, the computer of the consumer may be equipped with the DRAM having a huge memory capacity.

However, unless a special OS (Operation System), such as “Windows XP Server” is used, the typical OS, such as “Windows XP Home edition” or “Windows XP Professional”, available in the market, can support the addressing space of the memory capacity of at most 4 GB. For example, when the computer is equipped with the memory having the capacity of 8 GB and the OS is the “Windows XP Professional” that can only support the maximum addressing space of 4 GB, the memory capacity of only 4 GB can be used and the other 4 GB cannot be accessed. So, the memory capacity is wasted.

Consequently, it is an important subject of the invention to provide a device and a method for accessing an originally wasted memory space in the OS when the memory capacity in the system is getting larger and larger.

### SUMMARY OF THE INVENTION

In view of the foregoing, the invention is to provide a device and a method for accessing a redundant area of a memory.

To achieve the above, a memory accessing device of the invention includes a memory module, a CPU and a north bridge chipset. The memory module has an ordinary area and a redundant area. The CPU outputs redundant address data. The north bridge chipset includes a memory module controller, a data register and a pointer, which records the redundant address data. When a writing procedure is performed, the data register records to-be-stored data, and the memory module controller stores the to-be-stored data to a first physical address of the redundant area according to the pointer and the data register. The first physical address is determined according to the redundant address data. In addition, when a reading procedure is performed, the data register records a to-be-read amount, and the memory module controller reads to-be-read data from a second physical address of the redundant area according to the pointer and the data register. The second physical address is determined according to the redundant address data, and a data amount of the to-be-read data is determined according to the to-be-read amount.

In addition, the invention discloses a method for reading a memory, which is in conjunction with a CPU (Central Processing Unit), a north bridge chipset and a memory module. The north bridge chipset has a memory module controller, a data register and a pointer, and the memory module has an ordinary area and a redundant area. The method for reading a memory comprises the steps of: enabling the CPU to output redundant address data to the pointer; recording a to-be-read amount into the data register; and enabling the memory module controller to read to-be-read data from a physical address of the redundant area according to the pointer and the data register. Wherein, the physical address is determined according to the redundant address data, and a data amount of the to-be-read data is determined according to the to-be-read amount.

The invention further discloses a method for writing a memory, which is in conjunction with a CPU (Central Processing Unit), a north bridge chipset and a memory module. The north bridge chipset has a memory module controller, a data register and a pointer, and the memory module has an ordinary area and a redundant area. The method for writing a memory comprises the steps of: enabling the CPU to output redundant address data to the pointer; recording to-be-stored data into the data register; and enabling the memory module controller to store the to-be-stored data into a physical address of the redundant area according to the pointer and the data register. Wherein, the physical address is determined according to the redundant address data.

As mentioned above, the device and method for accessing the memory according to the invention access the redundant area of the memory module, which cannot be supported by the operation system, by respectively inputting the redundant address data and the to-be-stored data or the data amount of the to-be-read data outputted from the CPU to the data register and the pointer added in the north bridge chipset, and then by enabling the memory module controller to point to a physical address of the redundant area of the memory module.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a memory accessing device for performing a writing procedure according to a preferred embodiment of the invention;

FIG. 2 is a schematic illustration showing the memory accessing device for performing a reading procedure according to the preferred embodiment of the invention;

FIG. 3 is a schematic illustration showing the memory accessing device for accessing an ordinary area according to the preferred embodiment of the invention;

FIG. 4 is a flow chart showing a memory writing method according to the preferred embodiment of the invention;

FIG. 5 is a flow chart showing a memory reading method according to the preferred embodiment of the invention; and

FIG. 6 is a schematic illustration showing a memory accessing device according to another preferred embodiment of the invention.

### DETAILED DESCRIPTION OF THE INVENTION

The present invention will be apparent from the following detailed description, which proceeds with reference to the accompanying drawings, wherein the same references relate to the same elements.

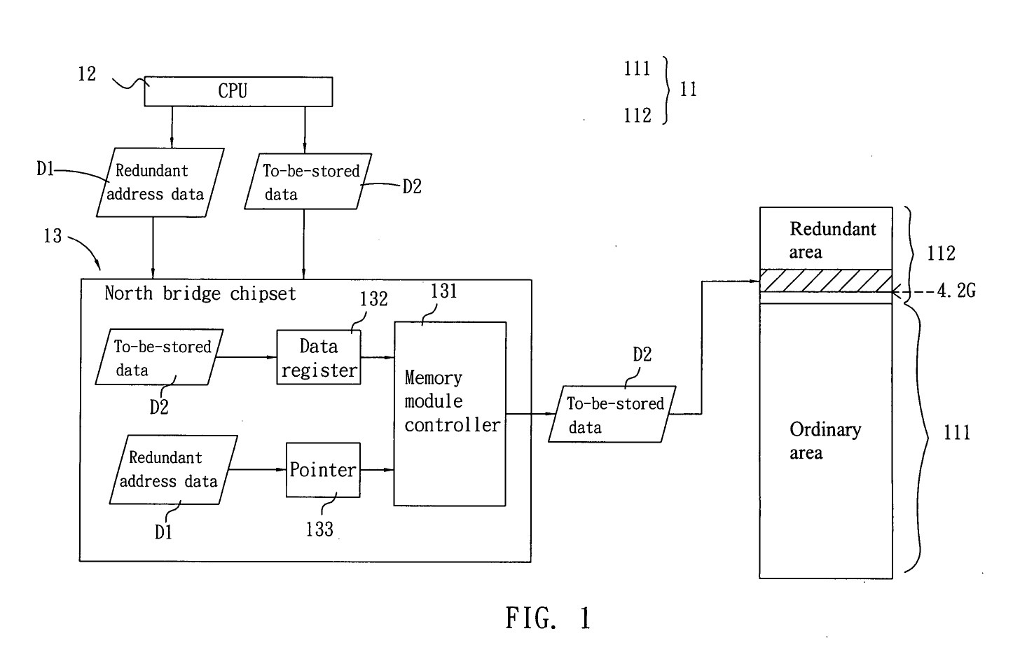

With reference to FIG. 1, a memory accessing device according to the preferred embodiment of the invention includes a memory module 11, a CPU (Central Processing Unit) 12 and a north bridge chipset 13.

The capacity of the memory module 11 is larger than the memory capacity supported by the computer operation system. In this embodiment, the computer operation system may be “Windows XP Professional” and the capacity of the memory module 11 is larger than 4 GB (GigaBytes). The memory module 11 has an ordinary area 111 and a redundant area 112. In this embodiment, the capacity of the memory module 11 is 7 GB, the addresses of the ordinary area 111 range from 0 to 3 G and the addresses of the redundant area 112 range from 4 G to 8 G

The CPU 12 outputs redundant address data D1 for generating the 4.2 G address in this embodiment.

The north bridge chipset 13 includes a memory module controller 131, a data register 132 and a pointer 133. In this embodiment, when a writing procedure is performed, the pointer 133 records the redundant address data D1 of the 4.2 G address. The data register 132 records to-be-stored data D2, and the memory module controller 131 stores the to-be-stored data D2 to a first physical address (4.2 G) of the redundant area 112 according to the pointer 133 and the data register 132. In this embodiment, the first physical address is determined according to the redundant address data D1.

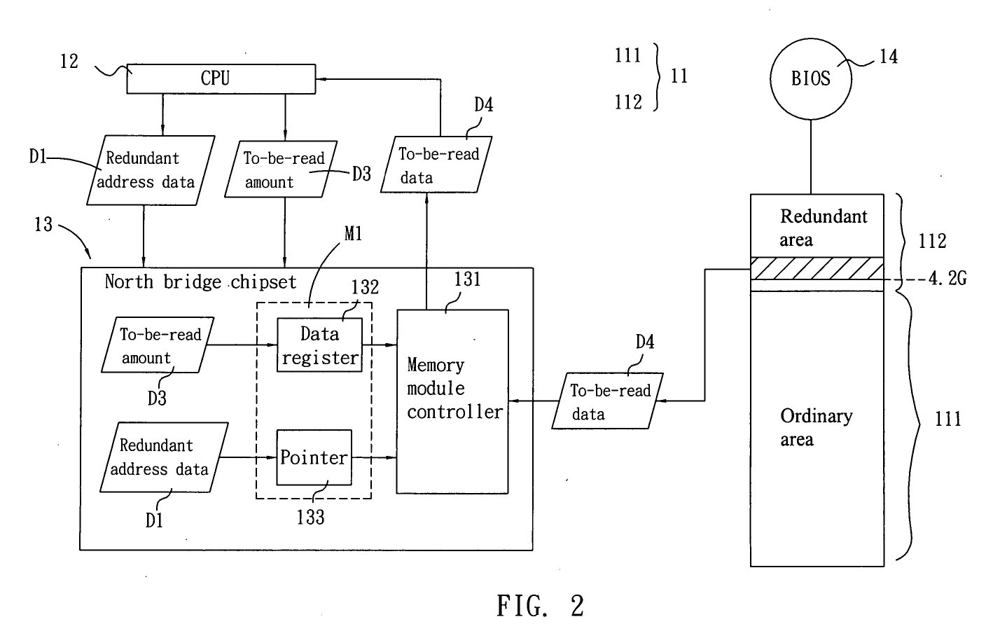

As shown in FIG. 2, the CPU 12 outputs the redundant address data D1 of the 4.2 G address, for example. When a reading procedure is performed, the pointer 133 records the redundant address data D1 of the 4.2 G address, and the data register 132 records a to-be-read amount D3, such as 64 bits, which represents that the data with the data amount of 64 bits is to be read from the 4.2 G address. The memory module controller 131 reads to-be-read data D4 with the data amount of 64 bits from a second physical address (4.2 G) of the redundant area 112 according to the pointer 133 and the data register 132, and transfers the to-be-read data D4 to the CPU 12. In this embodiment, the second physical address is determined according to the redundant address data D1, and the data amount of the to-be-read data D4 is determined according to the to-be-read amount D3. In addition, this embodiment further includes a BIOS (Basic Input Output System) 14 for storing the to-be-read data D4 into the redundant area 112 of the memory module 11, and the to-be-read data D4 may be, for example, the data required for the PCI (Peripheral Component Interconnect).

In the above-mentioned embodiment, the data register 132 and the pointer 133 may be disposed in a MMIO (Memory Mapping Input Output) register MI of the north bridge chipset 13.

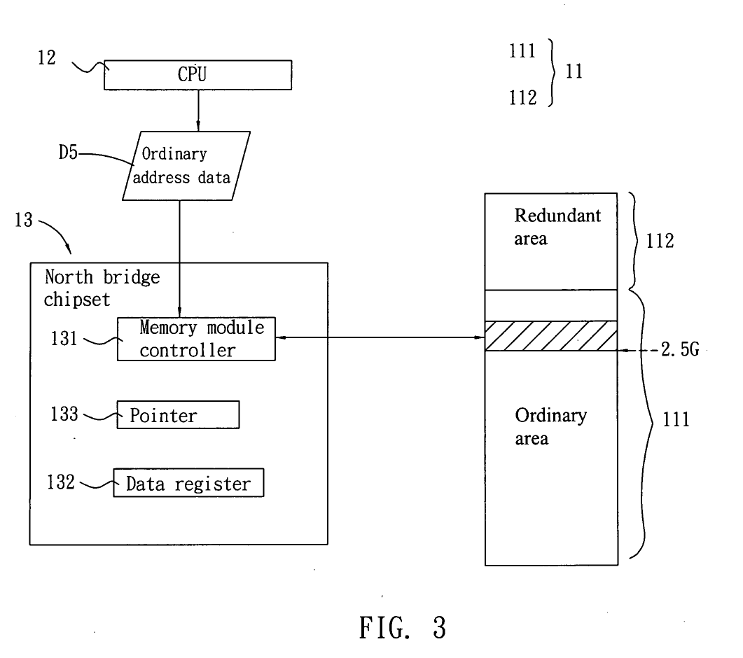

As shown in FIG. 3, in the current embodiment, if the CPU 12 generates ordinary address data D5 of the 2.5 G address, the memory module controller 131 points to the physical address (2.5 G) of the ordinary area 111 of the memory module 11 according to the ordinary address data D5 of the 2.5 G address and then performs the reading or writing procedure.

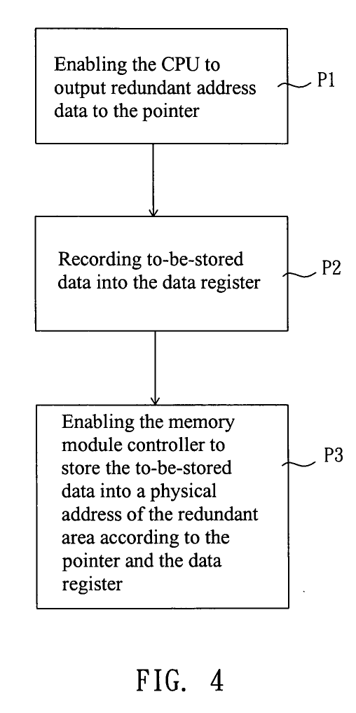

With reference to FIG. 1 in view of FIG. 4, the memory writing method of this embodiment is used in conjunction with a memory module 11, a CPU 12 and a north bridge chipset 13. The north bridge chipset 13 has a memory module controller 131, a data register 132 and a pointer 133. The memory module 11 has an ordinary area 111 and a redundant area 112. In this embodiment, the capacity of the memory module 11 is 7 GB, the ordinary area 111 is the addresses from 0 to 3 G, and the redundant area 112 is the addresses from 4 G to 8 G. The memory accessing method includes the following steps.

First, step P1 enables the CPU 12 to output redundant address data D1 to the pointer 133. In this embodiment, the redundant address data D1 is, for example, 4.2 G.

Next, step P2 records to-be-stored data D2 into the data register 132.

Finally, step P3 enables the memory module controller 131 to store the to-be-stored data D2 into a physical address (4.2 G) of the redundant area 112 according to the pointer 133 and the data register 132. In this embodiment, the physical address is determined according to the redundant address data D1.

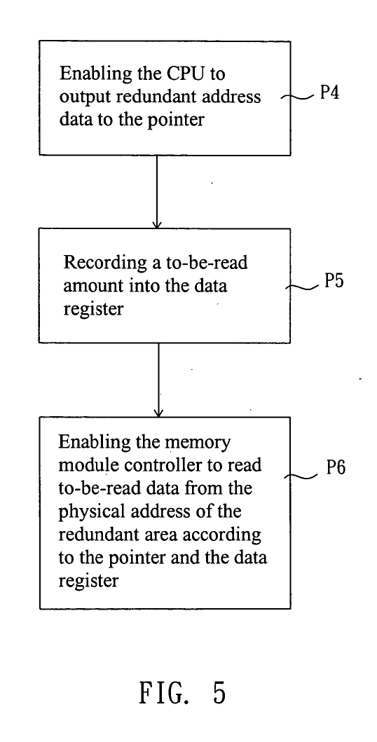

With reference to FIG. 2 in view of FIG. 5, the memory reading method of this embodiment is used in conjunction with a memory module 11, a CPU 12 and a north bridge chipset 13. The north bridge chipset 13 has a memory module controller 131, a data register 132 and a pointer 133. The memory module 11 has an ordinary area 111 and a redundant area 112. In this embodiment, the capacity of the memory module 11 is 7 GB, the ordinary area 111 is the addresses from 0 to 3 G, and the redundant area 112 is the addresses from 4 G to 8 G. The memory reading method includes the following steps.

First, step P4 enables the CPU 12 to output redundant address data D1 to the pointer 133. In this embodiment, the redundant address data D1 is, for example, 4.2 G.

Next, step P5 records a to-be-read amount D3 into the data register 132. For example, the to-be-read amount D3 is 64 bits, which represents that the data amount of the data to be read from the 4.2 G address is 64 bits.

Finally, the memory module controller 131 reads to-be-read data D4 with the data amount of 64 bits from the physical address (4.2 G) of the redundant area 112 according to the pointer 133 and the data register 132 (step P5), and transfers the to-be-read data D4 to the CPU 12. In this embodiment, the physical address is determined according to the redundant address data D1, and the data amount of the to-be-read data D4 is determined according to the to-be-read amount D3.

In addition, in the above-mentioned reading and writing methods, if the CPU 12 outputs ordinary address data D5 between 0 to 3 G, such as 2.5 G, to the memory module controller 131, the memory module controller 131 points to the physical address (2.5 G) of the ordinary area 111 of the memory module 11 according to the ordinary address data D5 (2.5 G), and then performs the reading or writing procedure.

In addition, except that the redundant area 112 is used to store the required data for the PCI, the redundant area 112 may serve as a buffer for the hard disk, a DMA (Direct Memory Access) buffer or a buffer for any data access.

To make the invention more comprehensive, another example is described hereinafter.

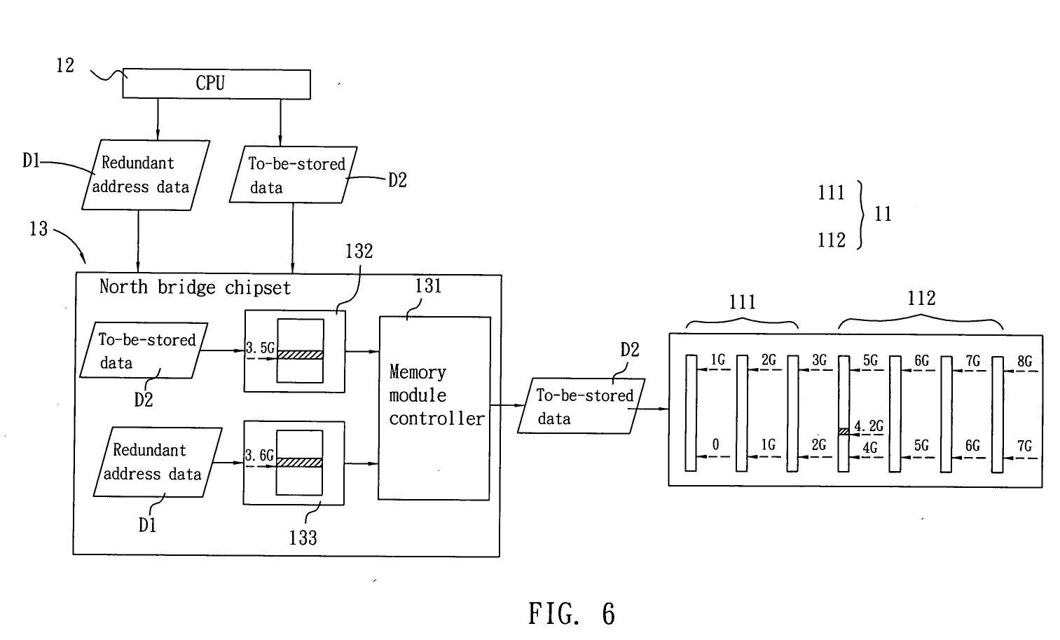

As shown in FIG. 6, the memory module 11 is composed of, for example, seven DRAMs, which include the ordinary area 111 composed of the addresses of 0 to 1 G, 1 G to 2 G, and 2 G to 3 G, and the redundant area 112 composed of the addresses of 4 G to 5 G, 5 G to 6 G, 6 G to 7 G, and 7 G to 8 G. In addition, the addresses of 3 G to 4 G are provided for other demands of the system. For example, the addresses of 3 G to 4 G are provided for the data storage of the PCI, the BIOS, or the memory output/input register. In this embodiment, the address 3.5 G is provided for the data register 132, and the address 3.6 G is provided for the pointer 133.

When the writing procedure is performed and when an operation system wants to store the to-be-stored data D2 into the 3.6 G address, the CPU 12 outputs the redundant address data D1 of, for example, the 4.2 G address to the pointer 133 of the 3.6 G address, and outputs the to-be-stored data D2 to the data register 132 of, for example, the 3.5 G address. Next, the memory module controller 131 stores the to-be-stored data D2 to the physical address (4.2 G) of the redundant area 112 according to the pointer 133 and the data register 132.

In summary, the memory accessing device and method of the invention add one set of a data register and a pointer to point the address and the data to the redundant area of the memory module such that the CPU can access the data stored in the memory larger than 4 GB when the operation system cannot support the memory space such as the memory space (i.e., the redundant area of the invention) larger than 4 GB in the Windows XP Professional operation system, for example. In addition, if the system has multiple sets of data registers and pointers, the operation may be performed in a more multiplex manner. Therefore, it is unnecessary to worry about the waste of the memory space due to the incapability of supporting the memory space in the operation system if the system has a huge memory capacity.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A memory accessing device, comprising:
a memory module having an ordinary area and a redundant area;
a CPU (Central Processing Unit) for outputting redundant address data; and
a north bridge chipset, which comprises a memory module controller, a data register and a pointer for recording the redundant address data, wherein
when a writing procedure is performed, the data register records to-be-stored data, and the memory module controller stores the to-be-stored data into a first physical address of the redundant area according to the pointer and the data register, wherein the first physical address is determined according to the redundant address data, and
when a reading procedure is performed, the data register records a to-be-read amount, and the memory module controller reads to-be-read data from a second physical address of the redundant area according to the pointer and the data register, wherein the second physical address is determined according to the redundant address data, and a data amount of the to-be-read data is determined according to the to-be-read amount.

2. The device according to claim 1, wherein the CPU further outputs ordinary address data, and the memory module controller operates according to the ordinary address data so as to point to a physical address of the ordinary area of the memory module.

3. The device according to claim 1, wherein the memory module has a capacity larger than a memory capacity supported by a computer operation system.

4. The device according to claim 3, wherein the memory capacity is about 4 GB.

5. The device according to claim 1, further comprising:
a BIOS (Basic Input Output System) for storing the to-be-read data into the redundant area of the memory module.

6. The device according to claim 1, wherein the pointer and the data register are disposed in a memory mapping input output (MMIO) register.

7. A method for reading a memory in conjunction with a CPU (Central Processing Unit), a north bridge chipset and a memory module, wherein the north bridge chipset has a memory module controller, a data register and a pointer, and the memory module has an ordinary area and a redundant area, the method comprising the steps of:
enabling the CPU to output redundant address data to the pointer;
recording a to-be-read amount into the data register; and
enabling the memory module controller to read to-be-read data from a physical address of the redundant area according to the pointer and the data register, wherein the physical address is determined according to the redundant address data, and a data amount of the to-be-read data is determined according to the to-be-read amount.

8. The method according to claim 7, further comprising the steps of:
enabling the CPU to output ordinary address data to the memory module controller; and
enabling the memory module controller to point to a physical address of the ordinary area of the memory module according to the ordinary address data.

9. A method for writing a memory in conjunction with a CPU (Central Processing Unit), a north bridge chipset and a memory module, wherein the north bridge chipset has a memory module controller, a data register and a pointer, and the memory module has an ordinary area and a redundant area, the method comprising the steps of:
enabling the CPU to output redundant address data to the pointer;
recording to-be-stored data into the data register; and
enabling the memory module controller to store the to-be-stored data into a physical address of the redundant area according to the pointer and the data register, wherein the physical address is determined according to the redundant address data.

10. The method according to claim 8, further comprising the steps of:
enabling the CPU to output ordinary address data to the memory module controller; and
enabling the memory module controller to point to a physical address of the ordinary area of the memory module according to the ordinary address data.
